(19) United States
(12) Patent Application Publication
(10) Pub. No.: US 2005/0213030 A1
(43) Pub. Date: Sep. 29, 2005

(54) CORRECTIVE LENS FOR CORNEAL RESHAPING AND METHOD OF DETERMINING THE DESIGN OF THE CORRECTIVE LENS

(76) Inventor: William E. Meyers, Scottsdale, AZ (US)

Correspondence Address: SNELL & WILMER;ONE ARIZONA CENTER, 400 EAST VAN BUREN, PHOENIX, AZ, 850040001, US

(21) Appl. No.: 10/906,601

(22) Filed: Feb. 25, 2005

Related U.S. Application Data
(60) Provisional application No. 60/547,860, filed on Feb. 25, 2004.
(60) Provisional application No. 60/548,533, filed on Feb. 26, 2004.

(51) Int. Cl. G02C 7/02

(52) U.S. Cl. 351/167

(57) ABSTRACT

The present invention includes corrective lenses for reshaping the cornea of an eye to improve vision, and methods of designing such corrective lenses. In accordance with various embodiments, the corrective lenses include a central portion, a periphery portion, and a junction region joining the central portion and the periphery portion comprised of a semi-rigid and/or flexible material. The corrective lenses are designed such that localized forces (e.g., lid forces and/or fluid forces in the eye) act on the corrective lenses to draw the periphery portion of a corrective lens to the corneal surface, which causes the junction region and/or central portion to apply pressure on the cornea to change the shape of the cornea. Because different individuals may require a different adjustment to their corneas to correct their particular problem, a corrective lens in accordance with the present invention may be specially designed to reshape the cornea of each user according to his/her particular needs.

### CROSS-REFERENCE TO RELATED APPLICATIONS

This application claims priority to U.S. Provisional Application No. 60/547,860 filed Feb. 25, 2004 and U.S. Provisional Application No. 60/548,533 filed Feb. 26, 2004, which provisional applications, in their entirety, are both hereby incorporated by reference.

### FIELD OF INVENTION

This invention generally relates to contact lenses, and particularly to, methods and devices for reshaping the cornea of an eye to treat visual acuity deficiencies. The invention is more particularly related to non-surgical methods of reshaping a cornea, and relates specifically to a method of determining the design of a corrective lens for reshaping the cornea of an eye.

### BACKGROUND OF INVENTION

In the treatment of visual acuity deficiencies, correction by means of eyeglasses or contact lenses are used by a large percentage of the population. Such visual acuity deficiencies include hyperopia or far-sightedness, and myopia or near-sightedness, astigmatisms (caused by asymmetry of a patients eye) and presbyopia (caused by loss of accommodation by the crystalline lens). To alleviate the burden of wearing eyeglasses and/or corrective lenses, surgical techniques have been developed for altering the shape of a patients cornea to correct refractive errors of the eye. Such surgical techniques include photorefractive keratectomy (PRK), LASIK (laser-assisted in-situ keratomileusis), as well as other procedures such as, automated lamellar keratoplasty (ALK), implanted corneal rings, implanted corrective lenses, and radial keratotomy (RK). These procedures are intended to surgically modify the curvature of the cornea to reduce or eliminate visual defects. The popularity of such techniques has greatly increased, however, such techniques still carry risk in both the procedures themselves, as well as post-surgical complications.

Alternatives to permanent surgical procedures to alter the shape of the cornea include corneal refractive therapy (CRT) and orthokeratology (also known as “ortho-K”), in which a modified contact lens is applied to the eye to alter the shape or curvature of the cornea by compression of the corneal surface imparted by the corrective lens.

### SUMMARY OF INVENTION

While the way in which the present invention addresses the disadvantages of the prior art will be discussed in greater detail below, in general, the present invention provides devices and methods for reshaping the cornea of an eye to improve deficiencies in eyesight related to conditions such as myopia, hyperopia, presbyopia, astigmatism, and other visual acuity deficiencies. For example, in accordance with various embodiments of the present invention, a flexible and/or a semi-rigid corrective lens is placed on the cornea for a period of time. The corrective lens includes a configuration which, over time, reshapes the cornea, and thus changes the focus of light as it passes through the cornea, thereby allowing correction of various visual acuity deficiencies.

### BRIEF DESCRIPTION OF THE DRAWINGS

A more complete understanding of the present invention may be derived by referring to the detailed description and claims when considered in connection with the drawing figures, where like reference numbers refer to similar elements throughout the figures, and:

FIG. 1 is a diagram of an exemplary embodiment of a corrective lens for reshaping of the cornea of an eye prior to localized forces of the patient acting on the corrective lens; and

FIG. 2 is a diagram of the corrective lens of FIG. 1 after localized forces have acted on the corrective lens to place the corrective lens in an appropriate position to reshape the cornea.

### DETAILED DESCRIPTION

The following description is of exemplary embodiments of the invention only, and is not intended to limit the scope, applicability, or configuration of the invention in any way. Rather, the following description is intended to provide a convenient illustration for implementing various exemplary embodiments of the invention. As will become apparent, various changes may be made in the function and arrangement of the elements described in these embodiments without departing from the scope of the invention as set forth in the appended claims.

That said, the present invention generally provides a corrective lens for reshaping the cornea of an eye to improve deficiencies in eyesight related to conditions such as, for example, myopia (near-sightedness), hyperopia (far-sightedness), presbyopia (gradual loss of the eyes ability to change focus for seeing near objects caused because of the lens becoming less elastic), astigmatism (distorted vision), and other such conditions caused by refractive errors in the eye. The invention also provides a method for determining the design of a corrective lens for a particular patient.

For proper eyesight, the cornea (the clear window in front of the eye) and the lens (located behind the pupil) must properly focus or “refract” light onto the retina (located at the back of the eye). If the length and/or shape of the eye is not ideal, the light may get focused too early or too late, leaving a blurred image on the retina. In the case of myopia, the eye is elongated (measuring from the front to the back of the eyeball), whereas in the case of hyperopia, the eye is shortened.

In accordance with various embodiments of the present invention, the cornea is reshaped to compensate for elongation, shortening, and/or other irregularities of the eye using a corrective lens. Such reshaping may be generally referred to herein as corneal refractive therapy, or CRT.

Corrective lenses of varying rigidity are known in the art for a variety of purposes. The term “rigid lens” is often used to refer to a lens that is substantially inflexible during normal use—that is, it retains its shape both before and after placement on the cornea. The term “soft lens” is often used to refer to a lens that, while capable of retaining its general shape during normal use, is generally flexible and tends to conform to the contours of a cornea more so than a rigid lens. The present invention relates particularly to what is referred to herein as “semi-rigid” lenses—corrective lenses that are generally flexible, but which exhibit sufficient rigidity to predictably apply forces to the cornea to effectuate corneal reshaping. In accordance with various aspects, the invention also particularly relates to what is referred to as “flexible” lenses—corrective lenses that function similar to soft lenses, but are still capable of applying force to the cornea to effectuate corneal reshaping.

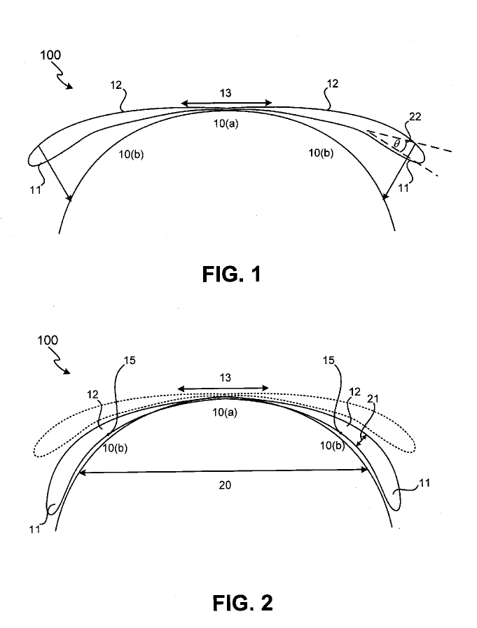

Preferably, the shape of the corrective lens approximates the shape of a conventional soft contact lens in its inverted state. Stated another way, while a conventional contact lens (either rigid or soft) conforms substantially to the curvature of the cornea, in accordance with an exemplary embodiment of the present invention, a corrective lens is designed such that it deviates from the cornea at the lens periphery (as shown in FIG. 1). During wear, fluid forces and/or lid forces draw a periphery portion 111 of a corrective lens 100 to a cornea 10, flexing lens 100 at a junction region 12 between center portion 13 of lens 100 and periphery portion 11 (as shown in FIG. 2). The leverage created at junction region 12 applies pressure directly below a leverage point 15 of corrective lens 100. These forces effectuate a stretching action across center portion 13 of lens 100, and center portion 13 applies a compressive force to a central corneal surface 10a. This action “thins” central corneal surface 10a, and thickens a mid-periphery corneal surface 10b (i.e., the area of cornea 10 located substantially below junction region 12). This corneal reshaping can improve visual acuity deficiencies, and is particularly beneficial in improving myopia.

Individual corneas vary in terms of their resistance to or acceptance of reshaping. For example, a cornea may be more or less susceptible to reshaping based on its pliability, thickness, the amount of correction needed, and the like. Thus, the specific time period for which a corrective lens should be worn to achieve a desired result may be based on such factors. For example, corrective lens 100 may be worn anywhere from one day to 30 days (or longer), and may be worn continuously or for intervals over the course of treatment with the lens (e.g., every other day, for 12 hour periods, at night, while sleeping, etc.) based on the characteristics of the individual cornea and the nature of the desired result. Moreover, the treatment period may be adjusted based upon actual reshaping of the cornea proceeding at a faster or slower pace than initially predicted. Thus, in accordance with one aspect of an exemplary embodiment of the present invention, by appropriate selection of the shape of the lens, the new shape of the cornea may be suitably predicted and controlled, and vision deficiencies can be improved.

In accordance with an exemplary embodiment of the invention, that corrective lens 100 is configured to include a diameter 20 (see FIG. 2), a thickness 21 (see FIG. 2), and an angle of the transition of curvature 22 (see FIG. 1) suitable to effectuate the proper leverage during wear to effectuate a desired amount of compressive force on central corneal surface 10a. While the optimal magnitudes of diameter 20 and the angle of the transition of curvature 22 will, of course, be dependent upon the particular size and shape of the cornea being treated, for a typical human cornea, the diameter 20 will be in the range of about 7 millimeters (mm) to about 10 mm, and the angle of the transition of curvature 22 will be in the range of about zero degrees to about 20 degrees. As such herein, the angle of the transition of curvature 22 means the difference in the instantaneous slope of the central radius of corrective lens 100 and the instantaneous slope of the curvature of periphery portion 11. Alternatively, the angle of the transition of curvature 22 may be described as an offset of the origin of the curvature of periphery portion 11 from the center axis of corrective lens 100.

Optimal magnitudes of thickness 21 in the various treatment zones of corrective lens 100 also are widely variable, depending on the materials used and the amount of correction desired/needed. In accordance with one aspect of an exemplary embodiment of the invention, center portion 13 has a thickness in the range of about 40 micrometers (μm) to about 90 μm, and preferably from about 50 μm to about 80 μm. Junction region 12, in one exemplary embodiment, includes a thickness in the range of about 100 μm to about 200 μm, and preferably from about 120 to about 150 μm. Peripheral portion 11, in an exemplary embodiment is less than about 200 μm thick, and is preferably less than 100 μm thick.

In accordance with an aspect of one exemplary embodiment of the invention, the chemical and mechanical properties of corrective lens 100 are selected to ensure biocompatibility and effective oxygen transport through corrective lens 100 during use, and particularly during use when the patient is sleeping. At the same time, the chemical and mechanical properties of corrective lens 100 should also be appropriately configured to ensure that application of corrective lens 100 results in a predictable application of force to the cornea (e.g., transmitting lid and fluid forces to the cornea) during wear. Achieving these dual objectives is particularly challenging in that the desired configuration of corrective lens 100 should exhibit the predictable corneal reshaping characteristics of a conventional “rigid” lens, while also offering the patient the comfort and biocompatibility of a conventional “soft” corrective lens.

In accordance with an exemplary embodiment of the present invention, at least four primary mechanical parameters of a semi-rigid lens material are selected such that the resulting corrective lens, when configured in accordance with the detailed description above, is capable of reshaping the cornea of an eye to affect visual acuity. In accordance with one aspect of an exemplary embodiment, the Young's modulus of the lens material ranges from about 1.0 to about 1.5 megapascals (MPa), and preferably from about 1.2 to about 1.27 MPa. In accordance with another aspect of an exemplary embodiment of the invention, the tensile strength of the lens material ranges from about 0.4 to about 0.9 MPa, and preferably from about 0.49 to about 0.8 MPa. In accordance with yet another aspect of an embodiment of the invention, the lens material is chosen such that the percentage elongation at break is from about 75% to about 175%, and preferably from about 80% to about 150%. Moreover, in accordance with a further aspect of an exemplary embodiment of the invention, the toughness of the lens material at break ranges from about 20 to about 800 mJ/cm², and preferably from about 27.5 to about 764 mJ/cm². It should be understood, however, that the values for Young's modulus, tensile strength, percent elongation at break, and toughness at break provided herein are exemplary only, and one skilled in the art may select a lens material with a parameter value(s) outside of these ranges that is nonetheless suitable for use in accordance with the other aspects of the invention and not depart from the spirit and scope of the present invention.

Additionally, in accordance with other exemplary embodiments of the present invention, corrective lens 100 may be configured to provide additional desired refractive properties. For example, because in some instances, alterations in the geometry of corrective lens 100 may be difficult to realize because of the side effects of reshaping forces, corrective lens 100 itself may be configured to adjust its optical power. For example, various diffractive optics may be used. By way of example, a diffractive pattern may be etched on the lens to yield corrective power.

Finally, it should be understood that various principles of the invention have been described in illustrative embodiments only, and that many combinations and modifications of the above-described structures, arrangements, proportions, elements, materials and components, used in the practice of the invention, in addition to those not specifically described, may be varied and particularly adapted to specific users and their requirements without departing from those principles.

1. A corrective lens for reshaping a cornea of an eye, comprising:
a center portion;
a periphery portion extending radially beyond said center portion; and
a junction region between said center portion and said periphery portion,
wherein at least one of said center portion, said periphery portion, and said junction region is comprised of a semi-rigid material.

2. The corrective lens of claim 1, wherein each of said center portion, said periphery portion, and said junction region is comprised of said semi-rigid material.

3. The corrective lens of claim 1, wherein said corrective lens comprises a diameter in the range of about 7 millimeters (mm) to about 10 mm.

4. The corrective lens of claim 1, wherein said center portion comprises a thickness in the range of about 40 micrometers (μm) to about 90 μm.

5. The corrective lens of claim 1, wherein said junction region comprises a thickness in the range of about 100 μm to about 200 μm.

6. The corrective lens of claim 1, wherein said peripheral portion comprises a thickness of less than about 200 μm.

7. The corrective lens of claim 1, wherein said semi-rigid material comprises a Young's modulus in the range of about 1.0 megapascals (MPa) to about 1.5 MPa.

8. The corrective lens of claim 1, wherein said semi-rigid material comprises a tensile strength in the range of about 0.4 MPa to about 0.9 MPa.

9. The corrective lens of claim 1, wherein said semi-rigid material comprises a percentage of elongation at break in the range of about 75% to about 175%.

10. The corrective lens of claim 1, wherein said semi-rigid material comprises a toughness at break in the range of about 20 millijoules per square centimeter (mJ/cm²) to about 800 mJ/cm².

11. The corrective lens of claim 1, further comprising:
a diffractive pattern configured to yield a corrective power.

12. The corrective lens of claim 1, wherein said periphery portion is configured to form an angle of the transition of curvature with the cornea in the range of about 0 degrees to about 20 degrees prior to localized forces acting on said corrective lens.

13. The corrective lens of claim 12, wherein said periphery is configured to exert force on the cornea after said localized forces have acted on said corrective lens,
wherein said force exerted by said periphery portion is sufficient to reshape at least the cornea.

14. A corrective lens for reshaping a cornea of an eye, comprising:
a center portion;
a periphery portion extending radially beyond said center portion; and
a junction region between said center portion and said periphery portion,
wherein at least one of said center portion, said periphery portion, and said junction region is comprised of a flexible material.

15. The corrective lens of claim 14, wherein each of said center portion, said periphery portion, and said junction region is comprised of said flexible material.

16. The corrective lens of claim 14, wherein said corrective lens comprises a diameter in the range of about 7 millimeters (mm) to about 10 mm.

17. The corrective lens of claim 14, wherein said center portion comprises a thickness in the range of about 40 micrometers (μm) to about 90 μm.

18. The corrective lens of claim 14, wherein said junction region comprises a thickness in the range of about 100 μm to about 200 μm.

19. The corrective lens of claim 14, wherein said peripheral portion comprises a thickness of less than about 200 μm.

20. The corrective lens of claim 14, further comprising:
a diffractive pattern configured to yield a corrective power.

21. The corrective lens of claim 14, wherein said periphery portion is configured to form an angle of the transition of curvature with the cornea in the range of about 0 degrees to about 20 degrees prior to localized forces acting on said corrective lens.

22. The corrective lens of claim 21, wherein said periphery is configured to exert force on the cornea after said localized forces have acted on said corrective lens,
wherein said force exerted by said periphery portion is sufficient to reshape at least the cornea.

23. A method to reshape a cornea of an eye utilizing a corrective lens, comprising the steps of:
measuring at least one characteristic of the cornea;
identifying a desired new shape for the cornea; and
configuring the corrective lens according to said characteristic to allow localized forces particular to a patient of the corrective lens to act on the corrective lens to reshape the cornea into said desired new shape.

24. The method claim 23, wherein said configuring step comprises the step of:
configuring the corrective lens such that said localized forces are allowed to act on the corrective lens to appropriately position the corrective lens on the cornea.

25. The method of claim 23, wherein said configuring step comprises the step of:
configuring the corrective lens such that said localized forces are allowed to exert force on a periphery portion of the corrective lens,
wherein said periphery portion is configured to substantially conform to a shape of the eye when force is exerted on said periphery portion, and
wherein said periphery portion is configured to cause a junction region of the corrective lens to exert force on the cornea sufficient to change the shape of the cornea into said desired new shape when force is exerted on said periphery portion.
